(19) United States
(12) Patent Application Publication
(10) Pub. No.: US 2007/0155924 A1
(43) Pub. Date: Jul. 5, 2007

(54) Starter systems II

(76) Inventors: Ludwig Schieferstein, Ratingen (DE); William LaMarca, Cregy les Meaux (FR)

Correspondence Address: COGNIS CORPORATION;PATENT DEPARTMENT, 300 BROOKSIDE AVENUE, AMBLER, PA, 19002, US

(21) Appl. No.: 10/555,285

(22) PCT Filed: Apr. 30, 2004
(86) PCT No.: PCT/EP04/04591

§ 371 Date: Aug. 9, 2006

(30) Foreign Application Priority Data
May 9, 2003 (DE) 103 20 904.2

(51) Int. Cl. C08F 4/28

(52) U.S. Cl. 526/227; 526/317.1; 502/160

(57) ABSTRACT

A starter system for polymerization of unsaturated monomers in a nonaqueous media is provided. The starter system comprises a peroxide compound (0.02% to 7%), an organic hydrazine derivative (0.005% to 3%) and a transition metal ion (1 to 1000 ppm) the concentation based on the polymerization mixture as a whole. The starter system prevents rapid polymerization and development of heat in the polymerization system at the beginning of the polymerization. The preferred nonaqueous solvents are aromatic hydrocarbons.

This invention relates to a starter system for the polymerization of unsaturated monomers, preferably acrylates and derivatives thereof, in nonaqueous solvents. The invention also relates to a polymerization process and to the use of certain mixtures as starter systems.

The polymerization of unsaturated monomers is one of the basic reaction types in industrial chemistry and is used for the production of a large number of intermediate and end products. In general, the monomers are dissolved in a suitable solvent and, in the case of radical reactions, started with corresponding radical initiators.

Such reactions are known from the prior art. Water is generally used as the solvent providing the desired monomers allow. Reference is made in this connection to the disclosure of EP-A-778 290 which discloses other general particulars of such reactions.

Polymerization reactions are also widely known in connection with nonaqueous systems. However, a temperature problem is often encountered during the polymerization. In the polymerization of acrylic acid, for example, the exothermy of the polymerization reaction is sufficient to heat the system to a temperature of 250° C. or higher. Even with the relatively difficult stearyl acrylate, the system is heated to >50° C. The high temperature, which is often reached in surges and cannot be dissipated sufficiently quickly by external cooling, leads to undesirably vigorous boiling of the reaction mixture. The lack of uniformity in the reaction conditions results in relatively poor reproducibility of the polymerization process, different monomers frequently being copolymerized. In order to solve this problem on an industrial scale, the monomer has hitherto been continuously replenished in practice and, at the same time, the reaction temperature has been controlled. This is both very time-consuming and expensive in terms of the equipment required. Accordingly, there has long been a need to be able to start the polymerization reaction in such a way that the above-mentioned disadvantages could be avoided.

Accordingly, the problem addressed by the present invention was to enable the polymerization of monomers to be carried out in nonaqueous solvents in such a way that exothermy surges, which heat the reaction mixture beyond the boiling point of components present therein, such as monomers and/or solvents, would be avoided and the reaction could be conducted in a simple manner.

It has been found that the problem stated above can be dissolved by the use of certain starter systems.

Accordingly, the present invention relates to a starter system for the polymerization of unsaturated monomers in non-aqueous media, the starter systems having to contain at least the components a), a peroxide compound in quantities of 0.02 to 7% by weight, b) organic hydrazine derivatives in quantities of 0.005 to 3% by weight and finally c), transition metal ions in quantities of 2 to 1,000 ppm. In this case, the quantities mentioned are all based on the system as a whole, i.e. monomer, solvent and starter system.

In principle, similar systems are already known from the prior art, cf. for example EP 0 550 087. However, this document describes foamable and curable polyester compositions which, besides a liquid unsaturated polyester resin, must also contain a monosubstituted sulfonyl hydrazine as blowing agent for the resin and at least one organic metal salt as primary promoter for the organic peroxide curing agent. In contrast to the present invention, the teaching of EP-A-0 550 087 does not start out from low molecular weight monomers, but uses an unsaturated liquid polyester resin, i.e. a polymer, for the reaction. In addition, the document in question does not disclose a solution polymerization in which the monomers are first dissolved and then reacted.

The starter system according to the invention has first and foremost to contain a peroxide compound a) which, during the reaction, releases radicals that start the actual polymerization reaction in known manner. Suitable peroxides are, for example, saturated aliphatic hydroperoxides, olefinic hydroperoxides, arylalkyl hydroperoxides, hydroperoxides of cycloaliphatic and heterocyclic organic molecules, dialkyl peroxides, hydroxyalkyl peroxides, polyalkylene peroxides, peroxyacetals, methyl hydroperoxides, ethyl hydroperoxide, tert.butyl hydroperoxides, dimeric benzaldehyde peroxides, dimeric benzophenone peroxides, dimeric acetone peroxide and methyl ethyl ketone hydroperoxide. However, methyl ethyl ketone peroxide and especially cumene hydroperoxide are particularly preferred as component a).

The peroxide compounds a) are present in quantities of 0.02 to 7% by weight, based on the mixture as a whole, and preferably in quantities of 0.1 to 1% by weight.

It is known to the expert that the peroxides mentioned above are not generally obtainable as pure substances, but are marketed in various formulations. They are preferably dissolved in suitable organic solvents and are then marketed as more or less concentrated preparations. The peroxides preferably used are alkyloxy peroxides as described above and, in particular, cumene hydroperoxide, preferred substances being those which can be activated at only 15° C., but preferably at 20 to 25° C. and thus start the actual polymerization reaction.

Besides component a), the starter system must contain an organic hydrazine derivative in quantities of 0.005 to 3% by weight. Component b) acts as a polymerization accelerator, organic hydrazine derivatives in the present context preferably being compounds corresponding to the general formula R¹—NH—NH—CO—R², in which R¹ represents alkyl, cycloalkyl, aryl, alkenyl, cycloalkenyl and R² represents hydrogen, alkyl, cycloalkyl, alkenyl, cycloalkenyl, aryl, alkoxy, aryloxy, carbonyl, an amino group or a sulfur-substituted aryl group.

Other particularly suitable compounds are those with the formula RSO₂—NH—NH₂, where R may be a hydrocarbyl radical selected from the group consisting of C₁₋₁₂ alkyl, C₅₋₆ cycloalkyl, C₇₋₁₀ arylalkyl, phenyl, naphthyl or substituted phenyl groups. Sulfonyl hydrazides, where R is a C₂₋₄ alkyl, benzyl or phenyl group, optionally substituted by chlorine or C₁₋₁₂ alkyl, are particularly advantageous.

Examples of suitable sulfonyl hydrazides are methanesulfonyl hydrazide, methanesulfonyl hydrazide, propanesulfonyl hydrazide, N-butanesulfonyl hydrazide, sec.butanesulfonyl hydrazide, tert.butanesulfonyl hydrazide, isobutanesulfonyl hydrazide, pentanesulfonyl hydrazide, hexanesulfonyl hydrazide, heptanesulfonyl hydrazide, octanesulfonyl hydrazide, nonanesulfonyl hydrazide, decanesulfonyl hydrazide, dodecanol sulfonyl hydrazide, cyclopentanesulfonyl hydrazide, cyclohexanesulfonyl hydrazide, benzenesulfonyl hydrazide, naphthalenesulfonyl hydrazide, toluenesulfonyl hydrazide, ethylbenzyl sulfonyl hydrazide, dimethylbenzenesulfonyl hydrazide, butylbenzenesulfonyl hydrazide, hexylbenzenesulfonyl hydrazide, octylbenzenesulfonyl hydrazide, decylbenzenesulfonyl hydrazide, ethoxybenzenesulfonyl hydrazides and other compounds of this class known to the expert. According to the invention, acetylphenyl hydrazide or toluenesulfonic acid hydrazide is particularly preferred as component b) in the starter systems.

Component b) is preferably present in the starter system in quantities of 0.03 to 0.3% by weight.

Transition metal ions in quantities of 1 to 1,000 ppm are used as another compulsory component c). Preferred ions emanate from copper, vanadium, molybdenum, cobalt or iron. In a particularly preferred embodiment, the ions are used in the form of their organic anions, preferably the salts of organic acids, suitable organic acids in this connection containing 2 to 20 carbon atoms and being selected from the group consisting of acetic acid, propionic acid, 2-ethylhexanoic acid, hexanoic acid, octanoic acid, oleic aid, palmitic acid, stearic acid, naphthalic acid. Complexes of such salts with acetoacetone are also suitable.

In a most particularly preferred embodiment, copper salts are used as component c), preferably in the form of a copper naphthenate. Component c) is preferably used in quantities of 3 to 15 ppm.

Suitable nonaqueous solvents for the polymerization reactions according to the invention are preferably liquid hydrocarbons, more particularly liquid aromatic hydrocarbons, especially toluene or xylene. However, mixtures of such solvents with other hydrocarbons, as marketed for example by Exxon under the name of Solvesso®, may also be used for the purposes of the present technical teaching.

The present reaction is the radical polymerization of certain unsaturated monomers. The monomers are preferably selected from the group consisting of acrylic acid and derivatives thereof and styrene. The group of acrylic acid and acrylic acid derivatives also includes methacrylic acid, methacrylates and other such substances. Even polyunsaturated monomers can be used, although it is particularly preferred to use the present starter system for the polymerization of monounsaturated monomers.

The present technical teaching does not encompass the use of unsaturated resins as in the case of the above-cited EP-A-0 550 087.

As known to the expert, the actual polymerization is carried out by first dissolving the monomers in the nonaqueous solvent and then adding the starter system. According to the invention, toluene may be added both to the monomers and to the starter system, so that there is no need for the complicated and expensive replenishment. By virtue of the particular properties of the starter system according to the invention, the temperature rises to at most 80° C. or lower, preferably even to below 70° C., at the start of the polymerization reaction. At all events, it remains below the boiling point of the solvent and monomers used, so that there is no need for complicated reflux cooling to condense the vapors otherwise formed.

In connection with this starter system and the process for the polymerization of unsaturated monomers using the starter systems described above, the present invention also relates to the use of mixtures of components a) to c), as described above, for starting polymerization reactions of unsaturated monomers and nonaqueous solvents.

The process according to the invention enables polymers of unsaturated monomers to be produced in a simple and reproducible manner. The disadvantages described above generally do not arise.

The polymers produced in accordance with the invention, particularly based on acrylic acid and its derivatives, are suitable for a wide range of industrial applications. It can be assumed that they may be used as process chemicals in the oilfield and mining sectors.

### EXAMPLE

500 g behenyl acrylate (Acrylate 22-45, a Cognis product) were melted at 65° C. and 120 g toluene were added to the resulting melt. The mixture was cooled to 35° C. while a gentle stream of nitrogen was passed over. 1.3 g acetylphenyl hydrazide, 3.8 g cumeme hydroperoxide (CUHP-80; 80% in cumene; Peroxid-Chemie) and 0.4 g of a 1% solution of “Soligen Kupfer 8”, a Borchers product (copper naphthenate dissolved in white spirit, copper content 8%) in toluene were then successively added with stirring. The temperature of the mixture rose to ca. 70° C. in a few minutes. After the increase in temperature had stopped, the mixture was heated to 80° C. and kept at that temperature for another hour. The mixture was then cooled and the polymer was obtained in the usual way.

The polymer solution obtained has a riser melting point of 32° C., as measured by DGF Einheitsmethode C-IV 3a (52), and a Brookfield viscosity of 600 mPas, as measured at 50° C., RVT spindle 4, 20 r.p.m.

1-11. (canceled)

12. A starter system for the polymerization of unsaturated monomers in nonaqueous media which comprises:
a) 0.02% to 7% by weight of a peroxide compound;
b) 0.005% to 3% by weight of an organic hydrazine derivative; and
c) 1 to 1,000 parts per million (ppm) of a transition metal ion;
wherein, the concentrations are based on a polymerization mixture as a whole including monomers, nonaqueous medium and starter system.

13. The starter system as claimed in claim 17, wherein, the peroxide compound comprises at least one member selected from the group consisting of methylethylketone peroxide and cumene hydroperoxide.

14. The starter system as claimed in claim 12, wherein, component a) is present in an amount of 0.1 to 1% by weight of the polymerization mixture.

15. The starter system as claimed in claim 12, wherein, component b) comprises at least one member selected from the group consisting of acetylphenyl hydrazide and toluenesulfonic acid hydrazide.

16. The starter system as claimed in claim 12, wherein, component b) is present in an amount of 0.03 to 0.3% by weight of the polymerization mixture. 17. The starter system as claimed in claim 12, wherein, component c) comprises ions of at least ore metal selected from the group consisting of copper, vanadium, molybdenum, cobalt and iron.

18. The starter system as claimed in claim 12, wherein, component c) comprises copper ions.

19. The starter system as claimed in claim 12, wherein, the nonaqueous solvent comprises at least one aromatic hydrocarbon.

20. The starter system as claimed in claim 12, wherein, the unsaturated monomers comprise at least one member selected from the group consisting of acrylic acid, methacrylic acid and derivatives thereof.

21. A process for the polymerization of unsaturated monomers, which comprises:
a) dissolving the monomer in a nonaqueous solvent to form a polymerizable mixture;
b) heating the polymerizable mixture to a temperature below 80° C.;
c) adding the starter system claimed in claim 12 to the heated polymerizable mixture, whereby, the polymerization is started.

22. The method of starting polymerization reactions of unsaturated monomers in nonaqueous solvents which comprises: introducing the starter mixture of claim 12 into a mixture of the unsaturated monomers in the nonaqueous solvent.

23. The starter system of claim 12, wherein, component c) is present in an amount of from 3 to 15 ppm.

24. The starter system of claim 13, wherein, component a) is present in an amount of 0.1 to 1% by weight of the polymerization mixture.

25. The starter system of claim 13, wherein, component b) comprises at least one member selected from the group consisting of acetylphenyl hydrazide and toluenesulfonic acid hydrazide.

26. The starter system of claim 13, wherein, component b) is present in an amount of 0.03 to 0.3% by weight of the polymerization mixture.

27. The starter system of claim 13, wherein, component c) comprises ions of at least one metal selected from the group consisting of copper, vanadium, molybdenum, cobalt and iron.

28. The starter system of claim 20, wherein, the nonaqueous solvent comprises at least one member selected from the group consisting of toluene and xylene.

29. The process of claim 21, wherein, the polymerizable mixture is heated to a temperature below 70° C.

30. The process of claim 21, wherein, the monomers comprise at least one member selected from the group consisting of acrylic monomers, methacrylic monomers, acrylate monomers, methacrylate monomers and styrene.
